(19) United States
(12) Patent Application Publication
(10) Pub. No.: US 2019/0110408 A1
(43) Pub. Date: Apr. 18, 2019

(54) DEVICES FOR TREE PROPPING AND RELATED METHODS

(71) Applicant: Michael Franklin, Jericho, NY (US)

(72) Inventor: Michael Franklin, Jericho, NY (US)

(21) Appl. No.: 15/784,289

(22) Filed: Oct. 16, 2017

(51) Int. Cl. A01G 9/12; A01G 23/00

(52) U.S. Cl. CPC A01G 9/12; A01G 23/00

(57) ABSTRACT

A device for supporting a tree limb. The device includes a Y-shaped structure comprising a V-shaped portion and a stem portion. In some embodiments, the V-portion can be situated to contact a tree branch or tree trunk to provide support to the tree. In embodiments, a telescoping stem portion having a longitudinal axis and first and second ends is provided. A releasable coupler can be included for varying the length of the telescoping stem portion between the first and second ends. A V-shaped portion is fixedly coupled to the first end of the stem portion.

### TECHNICAL FIELD

The present application relates to the technical field of propping devices that assist in supporting an upright object, and more particularly to propping devices that assist in supporting a tree and methods of using the same.

### BACKGROUND

Bracing or propping of trees is well known, and a number of approaches can be used. Commonly, several stakes are pounded into the ground at a distance from and around the periphery of the base of the tree, and a series of ropes, guy wires, wooden boards, or the like are connected to the tree's trunk or limbs at a point spaced above the ground and extended downwardly and outwardly for attachment to the ground-inserted stakes. While these types of arrangements function fairly well, the installation of such contraptions is time consuming, as the length of the lines, guy wires, or supports must be customized for the width and height of the tree and the installation often requires more than one laborer and multiple tools. Indeed, it is not uncommon for such tree bracing or propping construction to take 30 minutes or more per tree and to require more than one laborer, particularly with larger trees.

### SUMMARY

Embodiments described herein provide for a propping device that is configured to support trees across a range of widths without having to modify or adjust the device to accommodate a specific width. Embodiments herein can comprise a rigid structural component comprising two arms that are spaced apart and define a continuously tapering space therebetween, e.g., V-shaped arms. The two arms are configured to flank a portion of a tree thereby providing support to the portion of the tree. The tapering space between the two arms allows for the support of trees across a range of widths without having to adjust the spacing between the two arms.

A propping device as described herein can comprise a Y-shaped structure that includes a V-shaped portion and a stem portion. In embodiments, a telescoping stem portion having a longitudinal axis and first and second ends is provided. A releasable coupler can be included for varying the length of the telescoping stem portion between the first and second ends. The V-shaped portion is fixedly coupled to the first end of the stem portion. In embodiments, V-shaped portion comprises two arms which can be configured such that the angle between them is adjustable. In embodiments, V-shaped portion comprises two arms which can be configured such that arms are bendable.

Methods of using the propping device are also described.

These and other aspects, objects, features, and embodiments will be apparent from the following description and the appended claims. Those skilled in the art may use the components of the tree propping device together or separate and may apply techniques provided herein for other applications.

### BRIEF DESCRIPTION OF THE DRAWINGS

The drawings illustrate only example embodiments of a tree propping device and are therefore not to be considered limiting of its scope.

FIG. 1 illustrates a schematic side view of a tree propping device supporting a tree at the trunk.

FIG. 2 illustrates a schematic top view of the tree propping device shown in FIG. 1.

FIG. 3 illustrates a schematic top view of the upper portion of another embodiment of a tree propping device.

FIG. 4 illustrates a schematic top view of the upper portion of yet another embodiment of a tree propping device.

### DETAILED DESCRIPTION OF EXAMPLE EMBODIMENTS

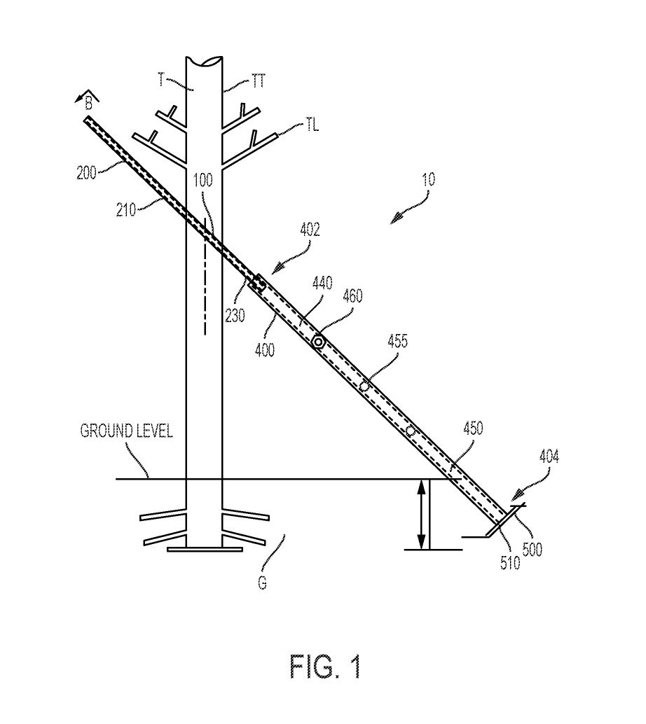

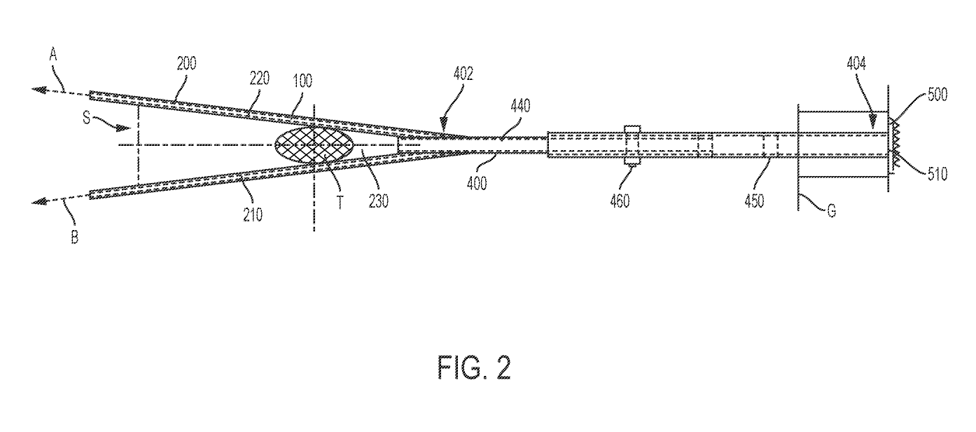

An embodiment of a propping device according to the invention is illustrated in FIGS. 1 and 2. The depicted embodiment of a propping device 10 is shown supporting a tree T that is rooted in ground G, but propping device 10 can be useful for supporting any object in need of a prop. With respect to trees, propping device 10 can support the tree trunk TT or a tree branch TB.

Propping device 10 comprises a Y-shaped rigid structure 100 having an upper V-shaped portion 200 and a lower stem portion 400 having a first end 402 and a second end 404. The V-shaped portion 200 is coupled to the stem portion 400 at the first end 402. The V-shaped portion 200 comprises two arms 210, 220 that form the V-shape. The two arms 210, 220 are spaced apart from each other to define an interior space S between the two arms 210, 220. Moreover, the two arms 210, 220 are configured so that interior space S is continuously tapering. The stem portion 400 can be an elongated rigid structure (e.g., a rigid pipe) configured to extend from the base 230 of the V-shaped portion 200 to the ground G when in use.

In the depicted embodiment, the stem portion 400 is configured to be adjustable in length, as measured between the first end 402 and the second end 404. Length adjustability permits the use of a single device with a variety of tree sizes. For example, the stem portion 400 can comprise a plurality of elongated members that are configured to telescope into one another. As shown, a rigid elongated member 440 (e.g., a rod or pipe) is configured to telescope into a rigid tubular member 450 (e.g., a pipe). Stem portion 400 further comprises a releasable coupler 460 configured to couple the rigid elongated member 440 in fixed relation to the rigid tubular member 440. The releasable coupler 460 can be configured to couple to the rigid elongated member 440, the rigid tubular member 450, or both at a plurality of fastening points 455. The plurality of fastening points 455 facilitates the stem portion being adjusted to different lengths. In the embodiment shown, the releasable coupler 460 is a pin and the fastening points 455 comprise a series of holes in members 440 and 450 configured to receive the pin. In some embodiments, the stem portion 400 can be configured such that it is adjustable in length over a range spanning at least 75 cm, e.g., spanning 75 cm to 300 cm. For example, the distance spanning the plurality of fastening points 455 would be at least 75 cm, e.g., spanning 75 cm to 300 cm.

The two arms 210, 220 are configured to accommodate trees across a range of widths without needing adjustments. In particular, in some embodiments, the two arms 210, 220 are configured so that the space S between the two arms is continuously tapering toward base 230. With such embodiments, portions of arm 210 would never be parallel to opposing portions of arm 220. For example, the two arms 210, 220 are closest to each other at the base 230 of the V-shaped portion 200 and furthest away from each other at the end opposite the base 230.

The length of and angle formed between (which impacts the size and shape of interior space S) each of the two arms 210, 220 can be any length and angle suitable for the range of tree sizes the device 10 would be designed to accommodate. In embodiments, the length of the two arms 210, 220 can be at least 20 cm each. In the depicted embodiment, the two arms 210, 220 are straight. The two straight arms 210, 220 each extend along a longitudinal axis A, B. The two arms 210, 220 can be oriented so that the axis A and axis B form an angle between 15 to 75 degrees or within a smaller range therebetween, such as 15-40 degrees, 25 to 50 degrees, or 50 to 75 degrees. In some embodiments, the longitudinal axes A, B of the two straight arms 210, 220 form an angle between 15 to 30 degrees and each straight arm has a length between 30 cm and 60 cm. While straight arms are depicted, the two arms 210, 220 can also be curved and oriented so that the arms 210, 220 curve away from each other such that the convex side of the two arms 210, 220 are facing each other.

Propping device 10 can also be configured to couple to the ground G that is adjacent and supporting the object to be propped, e.g., tree T. For example, propping device 10 can be configured so that the stem portion 400 at the second end 404 is coupled to an anchor 500 configured to engage with the ground G that is supporting the tree T. In the embodiment shown, the stem portion comprises a flange 510 at the second end 404. In use, the second end 404 would be buried in ground G and the flange 510 would impede the unearthing of the second end 404. Other anchors (not shown) can comprise a bolt, eye bolt, or other fastener components coupled to the second end 404 which are configured to couple to a corresponding fastener component of the anchor that is configured to be embedded or otherwise securely coupled to the ground G or a stable structure, such as a building. In lieu of an anchor, the second end 404 can be tapered for ease of insertion into the ground.

V-shaped portion 200 and the stem portion 400 can be composed of materials that are sufficiently durable to withstand the expected loads. For example, V-shaped portion 200 and the stem portion 400 can be composed of a rigid material such as a hard plastic, reinforced plastics, or metals.

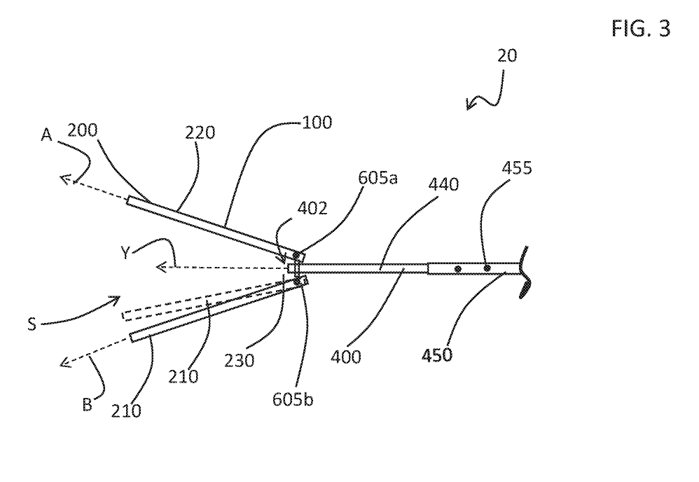

Another embodiment of a propping device according to the invention is illustrated in FIG. 3. The depicted embodiment of a propping device 20 is the same as propping device 10 shown in FIGS. 1 and 2 and described above, except that the two arms 210, 220 are configured such that the angle between the two arms 210, 220 (between axis A and B) is adjustable. In the embodiment shown, the two arms 210, 220 are coupled to the first end 402 of the stem portion 400 such that one or both arms 210,220 rotate relative to the stem portion 400 to adjust the relative position of the arms. One or both arms 210, 220 can independently rotate/pivot about an axis that is perpendicular to the longitudinal axis Y of the stem portion 400 thereby adjusting the angle between the two arms. Once the desired angle is obtained, one or both arms 210, 220 can be locked in that position. In the embodiment shown, both arms 210, 220 are coupled to stem portion via a hinge 605a, 605b, e.g., a lockable hinge. The two arms 210, 220 can be adjustable so that the angle between axis A and axis B can be set at angle between 15 to 75 degrees or set at an angle within a smaller range therebetween, such as 15-40 degrees, 25 to 50 degrees, or 50 to 75 degrees. By way of example, arm 210 is shown in dashed lines rotated to a second position.

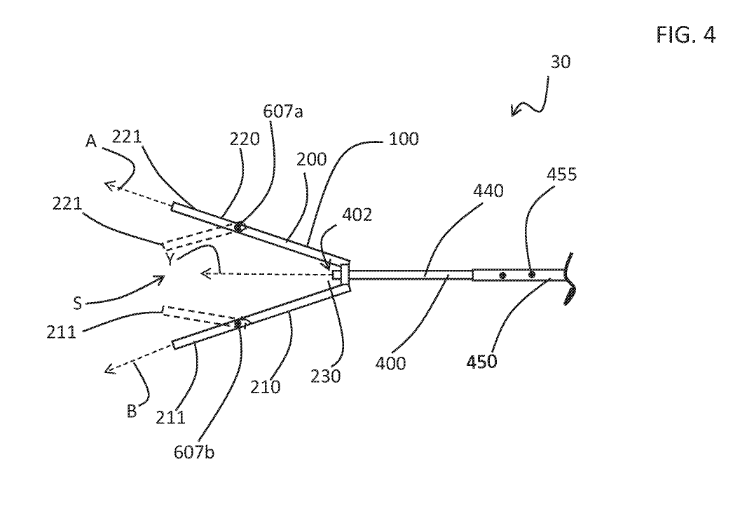

Another embodiment of a propping device according to the invention is illustrated in FIG. 4. The depicted embodiment of a propping device 30 is the same as propping device 10 shown in FIG. 1 and described above, except that arms 210,220 are configured to be bendable by way of a hinge 607a, 607b (e.g. a lockable hinge) located within an intermediate location of the arms 210, 220. In such embodiments, the end segments 211, 221 of arms 210, 200 can rotate toward each other such that the arms can embrace or wrap around tree T. By way of example, end segments 211,221 are shown in dashed lines rotated to a second position.

Another aspect of the present disclosure includes methods of propping a tree. Again with reference to FIGS. 1 and 2, the method of propping a tree can comprise obtaining a propping device, such as device 10 as shown in FIGS. 1 and 2 and positioning the V-shaped portion 200 such that a portion of the tree T (e.g., tree trunk TT or a tree branch TB) is in contact with the interior surface of the V-shaped portion 200 and the stem portion 400 is engaged with a ground G supporting the tree T. A second end 404 of the stem portion 400 can be anchored to the ground, such as be inserting the second end 404 into the ground G. To facilitate anchoring, the ground G around the site of insertion can be packed and/or backfilled with a heavy material, such as rocks or concrete.

The method can further comprise adjusting and setting the length of the stem portion 400 as required for the object to be propped. Releasable coupler 460 can be released to enable an adjustment in length of stem portion 400, such as by sliding rigid elongated member 440 in or out of rigid tubular member 450 so that V-shaped portion 200 makes suitable contact with object to be supported (e.g., tree T) and the second end 404 of the stem portion 400 makes suitable contact with ground G or some other stable/anchoring structure. Once length adjusted, releasable coupler 460 is reengaged to fix the length of the stem portion 400.

In instances where the propping device is used to support an object exposed the high winds, the Y-shaped support structure 100 can be positioned such that the stem portion 400 is aligned with the anticipated direction of the prevailing wind.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A propping device comprising:
a Y-shaped rigid structure comprising an upper V-shaped portion and a stem portion having a first end and a second end,
wherein the V-shaped portion comprises two arms defining a space therebetween,
wherein the space is continuously tapering,
wherein the V-shaped portion is coupled to the first end of the stem portion, and
wherein the stem portion has a length as measured between the first end and the second end and is configured to be adjustable in length.

2. The propping device of claim 1, wherein the stem portion at the second end is coupled to an anchor configured to engage with a ground that is supporting a tree.

3. The propping device of claim 2, wherein the second end is flanged.

4. The propping device of claim 1, wherein the stem portion is configured to be adjustable in length over a range spanning at least 75 cm.

5. The propping device of claim 1, wherein the Y-shaped structure and the stem portion are metal.

6. The propping device of claim 1, wherein the two arms are straight.

7. The propping device of claim 6, wherein the two straight arms each extend along a longitudinal axis, these axes forming an angle between 15 to 25 degrees, 25 to 50 degrees, or 50 to 75 degrees.

8. The propping device of claim 7, wherein the length of each of the two straight arms is at least 20 cm.

9. The propping device of claim 8, wherein the longitudinal axes of the two straight arms form an angle between 15 to 30 degrees and each straight arm has a length between 30 cm and 60 cm.

10. The propping device of claim 1, wherein the stem portion comprises a plurality of elongated members that are configured to telescope into one another.

11. The propping device of claim 10, further comprising a releasable coupler configured to couple the plurality of elongated member in fixed relation to each other.

12. The propping device of claim 1, further comprising a releasable coupler configured to couple to a plurality of fastening points on the stem portion thereby fixing the length of the stem portion.

13. A method of propping a tree comprising:
obtaining a Y-shaped support member comprising a V-shaped portion and a stem portion, wherein V-shaped portion comprises two arms having an interior surface defining an interior of the V-shape, with each arm coupled to the stem portion; and
positioning the Y-shaped support member such that a portion of the tree is in contact with the interior surface of the V-shaped portion and the stem portion is engaged with a ground supporting the tree.

14. The method of claim 13, further comprising inserting a portion of the stem portion into the ground.

15. The method of claim 13, further comprising packing the ground around the site of insertion.

16. The method of claim 13, wherein the Y-shaped support member is positioned such that the contact is with a tree trunk.

17. The method of claim 16, wherein the Y-shaped support member is positioned such that the longitudinal axis of the stem portion and the tree trunk define an angle, the angle being between 30-70 degrees.

18. The method of claim 13, wherein the Y-shaped support member is positioned such that the contact is with a tree branch.

19. The method of claim 13, further comprising adjusting and setting the length of the base.

20. The method of claim 13, wherein the Y-shaped support member is positioned such that the stem portion is aligned with the direction of a prevailing wind.
